(19) United States
(12) Patent Application Publication
(10) Pub. No.: US 2022/0069312 A1
(43) Pub. Date: Mar. 3, 2022

(54) METHOD AND SYSTEM TO CREATE VARIABLE DENSITIES WITHIN BATTERY ELECTRODES

(71) Applicant: GM Global Technology Operations LLC, Detroit, MI (US)

(72) Inventors: Nicholas P. Irish, Keego Harbor, MI (US); Ryan C. Sekol, Grosse Pointe Woods, MI (US); Dmitriy Bruder, Auburn Hills, MI (US)

(21) Appl. No.: 17/003,391

(22) Filed: Aug. 26, 2020

(51) Int. Cl. H01M 4/66; H01M 4/04; H01M 4/36

(52) U.S. Cl. CPC H01M 4/66; H01M 2220/20; H01M 4/366; H01M 4/0435

(57) ABSTRACT

A method to create variable densities within battery electrodes for motor vehicles includes one more of the following: providing a current collector; applying a first layer of active electrode material on a first surface of the current collector; and calendaring the first layer of active electrode material with a first textured roller to create a textured geometry on the surface on the first layer of active electrode material, a density gradient of the first layer of active electrode material being proportional to the textured geometry.

### INTRODUCTION

The present disclosure relates to battery electrodes for motor vehicles. More specifically, the present disclosure relates to a method and system to create variable densities within battery electrodes.

In growing numbers, motor vehicles are powered by electric motors or hybrid systems that combine electric motors with internal combustion engines. The electric motors typically receive energy from a battery pack with multiple cells. The electrodes for these battery cells, in particular thick electrodes, provide increased capacity but hinder other performance properties such as, for example, charging rates.

Thus, while current battery electrodes achieve their intended purpose, there is a need for a new and improved system and method for creating battery electrodes with variable densities to optimize the performance of the battery cells. For example, there is a need to produce battery cells with increased capacity while allowing for fast charging.

### SUMMARY

According to several aspects, a method to create variable densities within battery electrodes for motor vehicles includes one more of the following: providing a current collector; applying a first layer of active electrode material on a first surface of the current collector; and calendaring the first layer of active electrode material with a first textured roller to create a textured geometry on the surface on the first layer of active electrode material, a density gradient of the first layer of active electrode material being proportional to the textured geometry.

In an additional aspect of the present disclosure, the textured roller includes a plurality of projections.

In another aspect of the present disclosure, a contact angle of the plurality of projections on the surface of the layer of active electrode material determines a direction of the density gradient.

In another aspect of the present disclosure, a roller pressure and texture depth determine a magnitude of compaction of the layer of active electrode material.

In another aspect of the present disclosure, each of the plurality of projections have a conical shape.

In another aspect of the present disclosure, each of the plurality of projections have a frustoconical shape.

In another aspect of the present disclosure, the method further includes applying one or more additional layers of active electrode material on the first layer of active electrode material, wherein each layer is calendared with the textured roller.

In another aspect of the present disclosure, the method further includes applying a first layer of active electrode material on a second surface of the current collector and calendaring the first layer of active electrode material on the second surface of the current collector with a second textured roller to create a textured geometry on the surface on the first layer of active electrode material on the second surface of the current collector.

In another aspect of the present disclosure, the method further includes drying the first layer of active electrode material.

In another aspect of the present disclosure, the method further includes calendaring the first layer of active electrode material with a smooth roller.

According to several aspects, a system to create variable densities within battery electrodes for motor vehicles includes a current collector, a first layer of active electrode material applied on a first surface of the current collector, and a first textured roller to calendar the first layer of active electrode material to create a textured geometry on the surface on the first layer of active electrode material, a density gradient of the first layer of active electrode material being proportional to the textured geometry.

In another aspect of the present disclosure, the textured roller includes a plurality of projections.

In another aspect of the present disclosure, a contact angle of the plurality of projections on the surface of the layer of active electrode material determines a direction of the density gradient.

In another aspect of the present disclosure, a roller pressure and texture depth determine a magnitude of compaction of the layer of active electrode material.

In another aspect of the present disclosure, each of the plurality of projections have a conical shape.

In another aspect of the present disclosure, each of the plurality of projections have a frustoconical shape.

In another aspect of the present disclosure, one or more additional layers of active electrode material are applied on the first layer of active electrode material, wherein each layer is calendared with the textured roller.

In another aspect of the present disclosure, the first layer of active electrode material is dried.

In another aspect of the present disclosure, the first layer of active electrode material is calendared with a smooth roller.

According to several aspects, a system to create variable densities within battery electrodes for motor vehicles includes a current collector, one or more layers of active electrode material applied on a first surface of the current collector, one or more layer of active electrode material applied on a second surface of the current collector, a first textured roller to calendar each of the one or more layers of active electrode material applied on the first surface of the current collector to create a density gradient in the one or more layers of active electrode material on the first surface of the current collector, the density gradient being proportional to the textured geometry, and a second textured roller to calendar each of the one or more layers of active electrode material applied on the second surface of the current collector to create a density gradient in the one or more layers of active electrode material on the second surface of the current collector, the density gradient being proportional to the textured geometry.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 shows a system to produce battery electrodes according to an exemplary embodiment;

FIG. 2 is a close-up view of a calendaring roller for the system shown in FIG. 1 according to an exemplary embodiment;

FIG. 3 is a close-up view of projections over the outer surface of the calendaring roller shown in FIG. 2 according to an exemplary embodiment;

FIG. 4 is a side view of an electrode produced by the system shown in FIG. 1 according to an exemplary embodiment;

FIG. 5 is a perspective view of the electrode shown in FIG. 4 according to an exemplary embodiment;

FIGS. 6A, 6B and 6C are pictorial view of a process to produce an electrode according to an exemplary embodiment; and

FIG. 7 is pictorial view of another process to produce an electrode according to an exemplary embodiment.

### DETAILED DESCRIPTION

The following description is merely exemplary in nature and is not intended to limit the present disclosure, application, or uses.

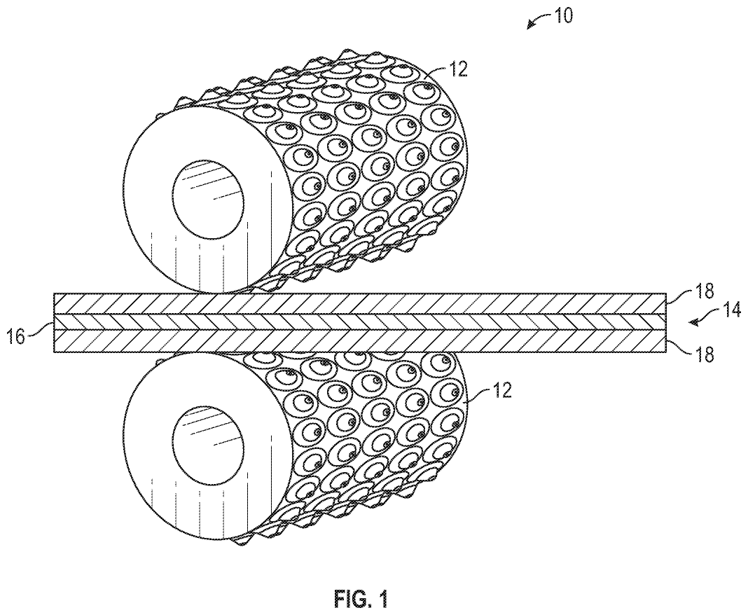

Referring to FIG. 1, there is shown a system 10 for creating battery electrodes for motor vehicles in accordance with the principles of the present disclosure. The system 10 includes one or a pair of rollers 12 to calendar active electrode material 18 applied to one or both sides of a current collector 16 to form an electrode 14, which is an anode or a cathode in a battery cell.

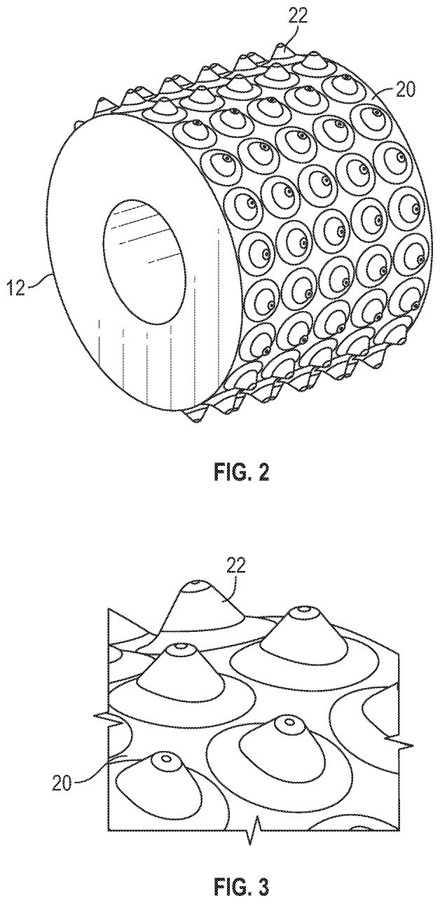

Turning to FIGS. 2 and 3 the roller 12 includes a set of projections 22 extending from an outer surface 20. In some arrangements, the projections 22 have a frustoconical shape as shown in FIGS. 2 and 3 to create dimples on the outer surface 20, but in other arrangements, the projections 22 can have any other suitable shape. Other textured surfaces, however, are contemplated for the outer surface 20. For example, in some arrangements, the outer surface 20 is knurled to create a desired texture on the surface 20.

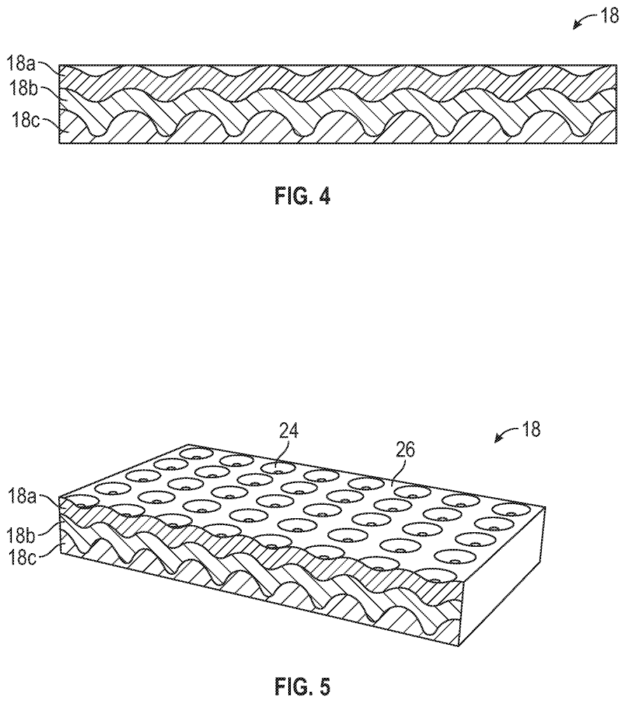

By texturing the active electrode material 18, the system 10 is capable of producing an electrode 14 with active electrode material 18 with variable densities. For example, as shown in FIGS. 4 and 5, rolling the textured calendar rollers 12 over the active electrode material 18 produces dimples 24 on the surface 26 of the active electrode material 18. These dimples, in turn, compact the active electrode material 18. The compaction results in a density gradient from the surface 26 towards the current collector 16. The density gradient is in general continuous, but for purposes of illustration three layers 18a, 18b and 18c are illustrated in FIGS. 4 and 5. Thus, the layer 18c is denser than the layer 18b, which in turn is denser than the layer 18a. Hence, the layer 18a has the lowest density or highest porosity and the layer 18c has the highest density or lowest porosity of the active electrode material 18. Accordingly, the layer 18c has higher energy density but lower diffusion of, for example, Li-ions, while the layer 18a has lower energy density but higher diffusion of ions.

Accordingly, a thicker layer of active electrode material 18 provides for increased capacity, while porosity gradients allow, for example, Li-ions to diffuse more quickly in higher porosity (lower density) areas such as layer 18a. Faster Li-ion diffusion provides faster charging and higher C-rates.

Note further that the density gradient is proportional to the geometry of the texture of the active electrode material 18 produced by the roller 12. The texture contact angle and area determine the gradient direction, and the roller pressure exerted by the roller 12 on the active electrode material 18 and the depth of the dimples 24 determine the magnitude of the compaction of the layers 18a, 18b and 18c.

In various arrangements, the desired thickness of the active electrode material 18 is textured in the calendaring process in a single step. In other arrangements, the thickness of the active electrode material is built up and calendared in multiple steps.

In various arrangements, textured rollers of various geometries are utilized to set different gap thicknesses (that is, pressure of compaction), which results in electrodes with variable densities. In certain arrangements, the surface 20 of the roller 12 is textured to create a micropatterned porosity of the surface 26 of the active electrode material 18.

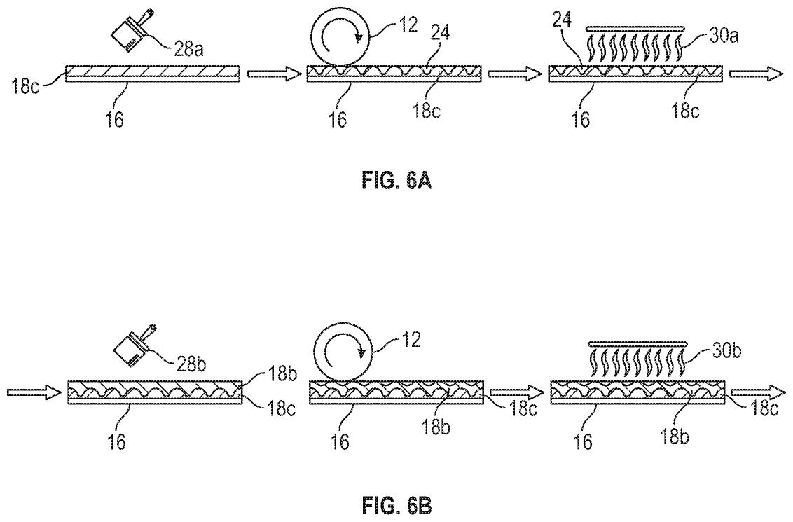

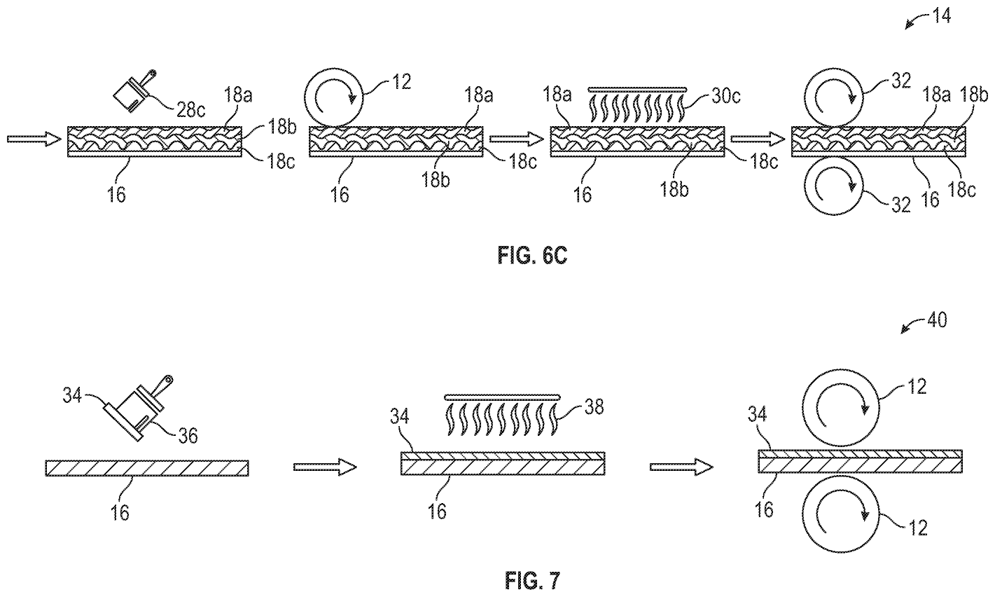

Turning now to FIGS. 6A, 6B and 6C, there is shown a pictorial process to apply multiple layers of active electrode material on the current collector 16. The layer of active electrode material 18c is applied to the current collector 16 with an application process 28a. The textured roller 12 is utilized to create indentations 24 in the layer 18c during a first calendaring step. Next, the layer 18c is dried by a heating process 30a.

The second layer of active electrode material 18b is applied on top of the layer 18c with an application process 28b. In a second calendaring step, the textured roller 12 produces indentations in the second layer 18b. A heating process 30b is utilized to dry the second layer 18b. Subsequently, the third layer 18a of active electrode material is deposited on top of the second layer 18b with an application process 28c. The textured roller 12 is again utilized to calendar the layer 18a. A heating process 30c is utilized to dry the layer 18a. The layers 18a, 18b and 18c, along with the current collector 16 are calendared between two smooth rollers 32. Note that the process is not limited to just three layers. Additional layers of active electrode material are applied in certain other arrangements, while in various arrangements one or two layers of active electrode material are applied to the current collector 16. In various arrangements, one or more layers of active electrode material are applied to the other side of the current collector 16 and then subsequently calendared with a textured roller 12. In various arrangements, an opposing smooth roller is utilized to provide counter pressure to the textured roller 12.

Turning to FIG. 7, there is shown yet another pictorial process to apply a layer of active electrode material to the current collector 16. A layer of active electrode material 34 is applied to the current collector in an initial step. The layer 34 is then dried by a heating process 38. A single textured roller 12 is utilized to create a texture in the layer 34 in certain embodiments, while a pair of textured rollers 12 is utilized to create textured patterns on layers of active electrode material 34 applied to both sides of the current collector 16.

Among other benefits and advantages, the above described system 10 and associated processes create battery electrodes with active electrode layers having variable densities. This enables the production of thicker electrodes with high capacities, while allowing for regions in the layers with higher porosity to quicker diffusion of ions for faster charging.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method to create variable densities within battery electrodes for motor vehicles, the method comprising:
providing a current collector;
applying a first layer of active electrode material on a first surface of the current collector; and
calendaring the first layer of active electrode material with a first textured roller to create a textured geometry on the surface on the first layer of active electrode material, a density gradient of the first layer of active electrode material being proportional to the textured geometry.

2. The method of claim 1, wherein the textured roller includes a plurality of projections.

3. The method of claim 2, wherein a contact angle of the plurality of projections on the surface of the layer of active electrode material determines a direction of the density gradient.

4. The method of claim 2, wherein a roller pressure and texture depth determine a magnitude of compaction of the layer of active electrode material.

5. The method of claim 2, wherein each of the plurality of projections have a conical shape.

6. The method of claim 2, wherein each of the plurality of projections have a frustoconical shape.

7. The method of claim 1, further comprising applying one or more additional layers of active electrode material on the first layer of active electrode material, wherein each layer is calendared with the textured roller.

8. The method of claim 1, further comprising applying a first layer of active electrode material on a second surface of the current collector and calendaring the first layer of active electrode material on the second surface of the current collector with a second textured roller to create a textured geometry on the surface on the first layer of active electrode material on the second surface of the current collector.

9. The method of claim 1, further comprising drying the first layer of active electrode material.

10. The method of claim 9, further comprising calendaring the first layer of active electrode material with a smooth roller.

11. A system to create variable densities within battery electrodes for motor vehicles, the system comprising:
a current collector;
a first layer of active electrode material applied on a first surface of the current collector; and
a first textured roller to calendar the first layer of active electrode material to create a textured geometry on the surface on the first layer of active electrode material, a density gradient of the first layer of active electrode material being proportional to the textured geometry.

12. The system of claim 11, wherein the textured roller includes a plurality of projections.

13. The system of claim 12, wherein a contact angle of the plurality of projections on the surface of the layer of active electrode material determines a direction of the density gradient.

14. The system of claim 12, wherein a roller pressure and texture depth determine a magnitude of compaction of the layer of active electrode material.

15. The system of claim 12, wherein each of the plurality of projections have a conical shape.

16. The system of claim 12, wherein each of the plurality of projections have a frustoconical shape.

17. The system of claim 11, wherein one or more additional layers of active electrode material are applied on the first layer of active electrode material, wherein each layer is calendared with the textured roller.

18. The system of claim 11, wherein the first layer of active electrode material is dried.

19. The system of claim 18, wherein the first layer of active electrode material is calendared with a smooth roller.

20. A system to create variable densities within battery electrodes for motor vehicles, the system comprising:
a current collector;
one or more layers of active electrode material applied on a first surface of the current collector;
one or more layer of active electrode material applied on a second surface of the current collector;
a first textured roller to calendar each of the one or more layers of active electrode material applied on the first surface of the current collector to create a density gradient in the one or more layers of active electrode material on the first surface of the current collector, the density gradient being proportional to the textured geometry; and
a second textured roller to calendar each of the one or more layers of active electrode material applied on the second surface of the current collector to create a density gradient in the one or more layers of active electrode material on the second surface of the current collector, the density gradient being proportional to the textured geometry.
